(19) United States
(12) Patent Application Publication
(10) Pub. No.: US 2026/0111913 A1
(43) Pub. Date: Apr. 23, 2026

(54) SUSTAINABLE INNOVATION PROFILER

(71) Applicant: Kenvue Brands LLC, Summit, NJ (US)

(72) Inventors: Jennifer K. Saxe, Bolton, MA (US); Eleanor Kirwan, Zurich (CH); Helene Marechal, Sotteville sous le val (FR); Lucas K. Piquini, Hillsborough, NJ (US); Oliver R. Price, Risch (CH); Kurt A. Reynertson, Hopewell, NJ (US); Catherine A. Smith, Bridgewater, NJ (US)

(21) Appl. No.: 19/355,334

(22) Filed: Oct. 10, 2025

Related U.S. Application Data
(60) Provisional application No. 63/708,281, filed on Oct. 17, 2024.

(51) Int. Cl. G06Q 30/018; G06Q 10/0631; G06Q 10/0639

(52) U.S. Cl. CPC G06Q 30/018; G06Q 10/0631; G06Q 10/06393

(57) ABSTRACT

Systems and methods for profiling sustainability of an innovation. The method includes designating a baseline product for a new product, the designated baseline product including at least a first baseline metric, a second baseline metric, and a third baseline metric; executing a first model to generate a first key metric for the new product associated with an environmental impact of the new product; executing a second model to generate a second key metric for the new product associated with a chemical analysis of the new product; executing a third model to generate a third key metric for the new product associated with a packaging analysis of the new product; evaluating the first baseline metric and the first key metric, the second baseline metric and the second key metric, and the third baseline metric and the third key metric; based on the evaluation, generating a recommendation for an update to the new product; and based on the generated recommendation, triggering an update to the new product.

### CROSS-REFERENCE TO RELATED APPLICATION

This application claims the benefit of U.S. Provisional Application No. 63/708,281 filed Oct. 17, 2024, the contents of which is incorporated herein by reference in its entirety.

### BACKGROUND

Product development includes an evaluation and analysis of not only the efficacy of a particular product, but also the sustainability of the product. The focus on product sustainability is driven both by consumers, who desire products with reduced negative environment impacts, such as by minimizing the carbon footprint of products and the amount of virgin plastic used in products, as well as by corporations who desire to produce and market such products. However, this can pose challenges in terms of identifying ingredients and packaging for such products that meet various, sometimes conflicting sustainability requirements. Further, current solutions fail to take into account a holistic view of products when determining their sustainability profile.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various implementations of the present disclosure described herein are directed to systems and methods that profile sustainability of an innovation. In one example, a computer-implemented method is provided. The computer-implemented method includes designating a baseline product for a new product, the designated baseline product including at least a first baseline metric, a second distinct baseline metric, and a third distinct and different baseline metric; capturing data associated with the new product; executing a first model to generate a first key metric for the new product, the first key metric associated with an environmental impact of the new product; executing a second model to generate a second key metric for the new product, the second key metric associated with a chemical analysis of the new product; executing a third model to generate a third key metric for the new product, the third key metric associated with a packaging analysis of the new product; evaluating the new product in view of the baseline product, including comparing the first baseline metric with the first key metric, the second baseline metric with the second key metric, and the third baseline metric with the third key metric; based on the evaluation, generating a recommendation for an update to the new product; and based on the generated recommendation, triggering an update to the new product.

In another example, a system is provided. The system includes a memory and a processor coupled to the memory. The processor is configured to designate a baseline product for a new product, the designated baseline product including at least a first baseline metric, a second baseline metric, and a third baseline metric; capture data associated with the new product; execute a first model to generate a first key metric for the new product, the first key metric associated with an environmental impact of the new product; execute a second model to generate a second key metric for the new product, the second key metric associated with a chemical analysis of the new product; execute a third model to generate a third key metric for the new product, the third key metric associated with a packaging analysis of the new product; evaluate the new product in view of the baseline product, including comparing the first baseline metric with the first key metric, the second baseline metric with the second key metric, and the third baseline metric with the third key metric; based on the evaluation, generate a recommendation for an update to the new product; and based on the generated recommendation, trigger an update to the new product, the triggered update including an ingredient replacement in the new product.

In another example, one or more non-transitory computer readable medium are provided. The one or more non-transitory computer readable medium stores instructions that, when executed by a processor, cause the processor to designate a baseline product for a new product, the designated baseline product including at least a first baseline metric, a second baseline metric, and a third baseline metric; capture data associated with the new product; execute a first model to generate a first key metric for the new product, the first key metric associated with an environmental impact of the new product; execute a second model to generate a second key metric for the new product, the second key metric associated with a chemical analysis of the new product; execute a third model to generate a third key metric for the new product, the third key metric associated with a packaging analysis of the new product; evaluate the new product in view of the baseline product, including comparing the first baseline metric with the first key metric, the second baseline metric with the second key metric, and the third baseline metric with the third key metric; based on the evaluation, generate a recommendation for an update to the new product; and based on the generated recommendation, trigger an update to the new product, the triggered update including an ingredient replacement in the new product.

Other technical features may be readily apparent to one skilled in the art from the following figures, descriptions, and claims.

### BRIEF DESCRIPTION OF THE DRAWINGS

The present description will be better understood from the following detailed description read in light of the accompanying drawings, wherein:

FIG. 1 illustrates an example system for profiling sustainability of an innovation according to an example;

FIG. 2 illustrates an example computer-implemented method of profiling sustainability of an innovation according to an example;

FIG. 3 illustrates an example data hub system according to an example;

FIG. 4 illustrates an example lifecycle analyzer system according to an example;

FIG. 5 illustrates an example green formulation analyzer system according to an example;

FIG. 6 illustrates an example computer-implemented method of analyzing a formulation according to an example;

FIG. 7 illustrates an example sustainable packaging analyzer system according to an example;

FIGS. 8A-8B illustrate example user interfaces for a sustainable innovation profiler according to an example; and

FIG. 9 is a block diagram of an example computing device 900 for implementing aspects disclosed herein.

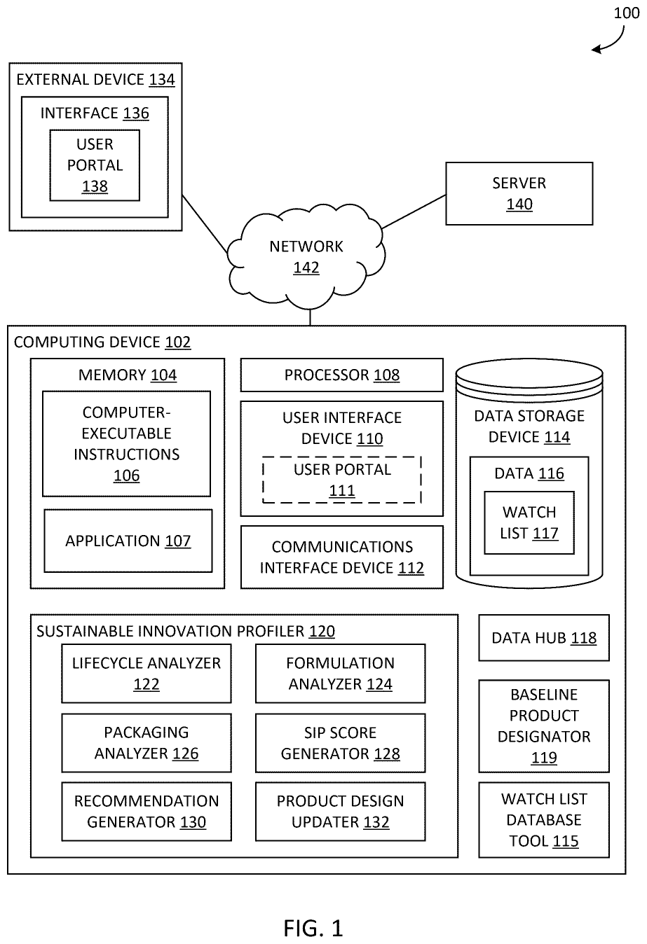

Corresponding reference characters indicate corresponding parts throughout the drawings. In FIGS. 1 to 9, the systems are illustrated as schematic drawings. The drawings may not be to scale.

### DETAILED DESCRIPTION

The various implementations and examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all examples.

As described herein, a significant focus is placed on developing and producing products that are more sustainable than existing products. Sustainable products are those that include ingredients and packaging that provide less harm to the environment than existing products, given state of the art technologies to deliver a particular consumer benefit, such as using renewable resources, recycled ingredients or packaging, and so forth, throughout the product lifecycle. However, current solutions fail to accurately and completely capture the effect that a product has on the environment. For example, current solutions may view this challenge through only a single lens, such as by taking into account only the ingredients, or possibly only some of the ingredients, of a formulation, but fail to take into account the entirety of the formulation, for example, because of the method of assessment requires data that does not exist for all chemicals in a formulation. As another example, current solutions may include an analysis of part of a product life cycle, such as how a product will impact the environment on disposal, but fails to include an analysis of the initial sourcing of the ingredients in the product. Or, as yet another example, current solutions may account for the product itself but fail to account for the packaging of the product that has an independent effect on the product separate from the product itself.

Various examples of the present disclosure recognize and take into account these challenges and provide systems and methods for creating sustainable products that are more sustainable than existing products through a robust analysis of an entire product including the environmental impact of a product, a chemical analysis of the product, and an analysis of the packaging of the product. This analysis is then used to generate both sustainability scores for each aspect of the product as well as an overall sustainability score, which is in turn used to generate a recommendation associated with the product. In some examples, the results of the generated recommendation is further used to automatically trigger an acceptance or rejection of the product that has been analyzed.

The systems and methods for performing guided image capture operate in an unconventional manner by implementing multiple models that operate in conjunction to quantify the environmental impact of a product by leveraging multiple internal and external sources to simultaneously analyze multiple aspects of a new product to ensure the new product is provided at a higher level of sustainability than an old product the new product is replacing. The multiple models work in conjunction to generate complementary but distinct metrics that are used to determine the sustainability of the new product, compare the metrics to baseline metrics of an existing baseline product or analogous product, and generate recommendations for improving the sustainability of the new product based on the comparison to the baseline product.

Accordingly, the systems and methods provides a technical solution to the inherently technical problem of performing technical calculations for the specific technical purpose or implementation of generating a recommendation for a new product to ensure the new product is provided at a higher level of sustainability than a baseline product that the new product is replacing. In particular, current solutions are faced with the technical problem of performing calculations that address chemical, packaging, and lifecycle concerns due to the overwhelming quantity of data that is collected and used in such analysis. The present application provides a technical solution to this technical problem by providing multiple artificial intelligence (AI) models that work in conjunction to simultaneously analyze each respective concern, generate a separate metric associated with each respective concern, and dynamically weight each generated metric separately in order to generate customized recommendations for improving the sustainability of the new product and/or the packaging of the new product.

FIG. 1 illustrates an example system for profiling sustainability of an innovation according to an example. The system 100 illustrated in FIG. 1 is provided for illustration only. Other examples of the system 100 may be used without departing from the scope of the present disclosure. In some examples, the system 100 profiles sustainability of an innovation in order to recommend and trigger product design changes to increase the sustainability of the innovation according to one or more examples described herein.

The system 100 includes a computing device 102, an external device 134, a server 140, and a network 142. The computing device 102 represents any device executing computer-executable instructions 106 (e.g., as application programs, operating system functionality, or both) to implement the operations and functionality associated with the computing device 102. The computing device 102 in some examples includes a mobile computing device or any other portable device. A mobile computing device includes, for example but without limitation, a mobile telephone, laptop, tablet, computing pad, netbook, gaming device, and/or portable media player. The computing device 102 may also include less-portable devices such as servers, desktop personal computers, kiosks, or tabletop devices. Additionally, the computing device 102 may represent a group of processing units or other computing devices.

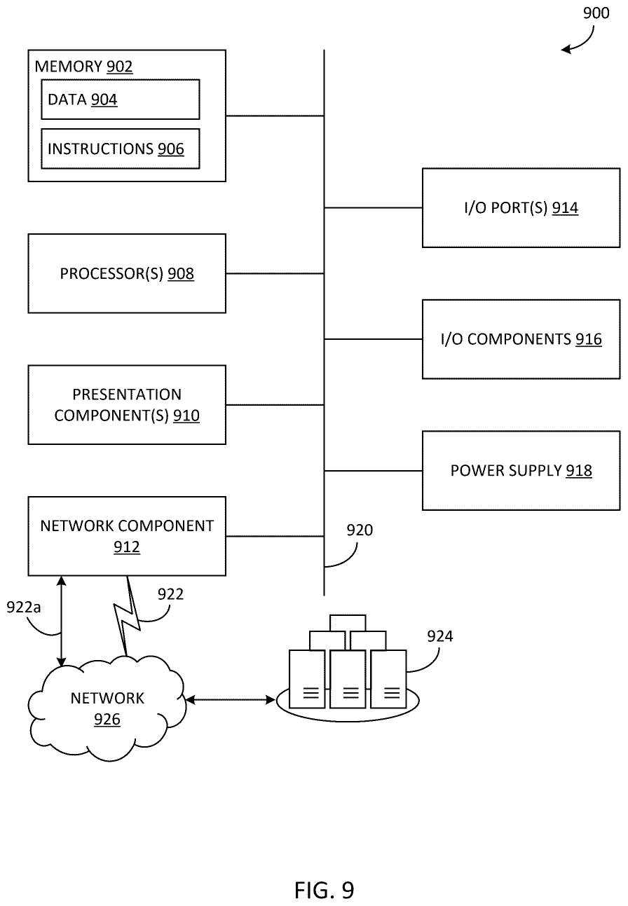

In some examples, the computing device 102 includes at least one processor 108, a memory 104 that includes the computer-executable instructions 106, and a user interface device 110. The processor 108 includes any quantity of processing units and is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIG. 9. In various examples, the processor 108 is configured to execute computer-executable instructions of one or more of a watch list database tool 115, data hub 118, baseline product designator 119, and a sustainable innovation profiler (SIP) 120.

The memory 104 includes any quantity of media associated with or accessible by the computing device 102. In some examples, the memory 104 is internal to the computing device 102. In other examples, the memory 104 is external to the computing device 102 or both internal and external to the computing device 102. For example, the memory 104 may include both a memory component internal to the computing device 102 and a memory component external to the computing device 102, such as the server 140. The memory 104 stores data, such as one or more applications 107. The applications 107, when executed by the processor 108, operate to perform various functions on the computing device 102. The applications 107 may communicate with counterpart applications or services, such as web services accessible via the network 142. In an example, the applications 107 represent server-side services of an application executing in a cloud, such as a cloud server 140. In some examples, the application 107 is an application for performing guided image capture as described herein.

The user interface device 110 includes a graphics card for displaying data to a user and receiving data from the user. The user interface device 110 may also include computer-executable instructions, for example a driver, for operating the graphics card. Further, the user interface device 110 may include a display, for example a touch screen display or natural user interface, and/or computer-executable instructions, for example a driver, for operating the display. The user interface device 110 may also include one or more of the following to provide data to the user or receive data from the user: speakers, a sound card, a camera, a microphone, a vibration motor, one or more accelerometers, a BLUETOOTH® communication module, global positioning system (GPS) hardware, and a photoreceptive light sensor. In a non-limiting example, the user inputs commands or manipulates data by moving the computing device 102 in one or more ways.

In some examples, the user interface device 110 presents a user portal 111. The user portal 111 includes a user interface, a calculator, and a simulator. The user portal 111 is the interface through which a user of the system 100 and/or the computing device 102 interacts with the sustainable innovation profiler 120, as discussed in greater detail below, to input data, such as formulation data, raw material data, packaging data, and so forth, into the calculator and/or simulator that is then analyzed by the sustainable innovation profiler 120.

The computing device 102 further includes a communications interface device 112. The communications interface device 112 includes a network interface card and/or computer-executable instructions, such as a driver, for operating the network interface card. Communication between the computing device 102 and other devices, such as but not limited to the external device 134 and/or the server 140, may occur using any protocol or mechanism over any wired or wireless connection.

The computing device 102 further includes a data storage device 114 for storing data 116. The data 116 includes, but is not limited to, raw ingredient data, formulation data, source data associated with one or more ingredients, packaging data, transportation data associated with raw ingredients and/or a formulation, production and manufacturing data, distribution and supply chain data, product use data, end of life data, related sustainability data such as emission data, and any other suitable data used by the system 100.

The computing device 102 further includes a watch list database tool 115. The watch list database tool 115 is a specialized processing unit, or units, executed on the processor 108 that performs various watch list related functions, including generating and maintaining a watch list 117 of ingredients that, while presently acceptable, emerging information suggests the potential for future restrictions or limitations in use and the need for reformulation if included in a new product and/or the packaging of a new product. In some examples, the generated watch list 117 is stored in the data storage device 114 as an example of data 116. Although illustrated in FIG. 1 as a component of the computing device 102, various examples are possible. For example, the watch list database tool 115 may be implemented on an external device, such as the external device 134, or another external device connected to the computing device 102 via the network 142.

The computing device 102 further includes a data hub 118. The data hub 118, also referred to as a sustainability data hub, is a specialized processing unit, or units, executed on the processor 108 that performs various data related functions, including data collection, data processing, data cataloging, and transmission of data. The data hub 118 calculations and/or insights generated by the data hub 118 are stored in a central, accessible location, such as on the data storage device 114, and may be available to the various components included within the computing device 102 as well as downstream systems and tools.

The computing device 102 further includes a baseline product designator 119. The baseline product designator 119 is a specialized processing unit, or units, executed on the processor 108 that identifies and designates a baseline product for a new product. The designated baseline product includes at least a first baseline metric, a second baseline metric, and a third baseline metric that correspond to a first key metric, second key metric, and third key metric as described in greater detail below. The designated baseline product, and its associated baseline metrics, serve as a baseline, or standard, for a new product in order to determine and improve sustainability of the new product.

The computing device 102 further includes the sustainable innovation profiler (SIP) 120. The SIP 120 is a specialized processing unit, or units, executed on the processor 108 that executes a series of models, such as artificial intelligence (AI) model, each of which analyzes a different aspect of a product to generate a separate score regarding the analyzed aspect of the product. For example, the SIP 120 includes a lifecycle analyzer 122, a formulation analyzer 124, a packaging analyzer 126, an SIP score generator 128, and recommendation generator 130, and a product design updater 132. Each of the lifecycle analyzer 122, formulation analyzer 124, packaging analyzer 126, SIP score generator 128, recommendation generator 130, and product design updater 132 are examples of specialized processing units implemented on the SIP 120 that perform specialized, respective functions.

The lifecycle analyzer 122 implements a first model that generates a first key metric associated with an environmental impact of a new product based on a plurality of impact areas. In some examples, the first key metric is referred to as a product environmental footprint (PEF). In some examples, the lifecycle analyzer 122 analyzes sixteen impact areas. However, more or fewer impact areas may be analyzed. Various examples are possible. Various impact areas may include, but are not limited to, ecosystems affected by the new product, human health affected by the new product, the effect the new product may have on climate change such as carbon footprint, natural resources that may be affected by the new product, and the effect of the new product on water. The analysis of ecosystems affected by the new product includes separate analysis of acidification, terrestrial eutrophication, freshwater cutrophication, marine cutrophication, and freshwater ccotoxicity. The analysis of how human health may be affected by the new product includes separate analysis of ozone depletion, human toxicity including cancer effects, human toxicity including non-cancer effects, particulate matter, ionizing radiation, and photochemical ozone formation. The analysis of climate change includes an analysis of the new product on global warming. The analysis of natural resources that may be affected by the new product includes an analysis of mineral resource depletion, non-renewable energy resource depletion, and land use. The analysis of the effect of the new product on water includes an analysis of the water scarcity footprint due to the new product. As described in greater detail below, the lifecycle analyzer 122 generates the first key metric based on the analysis of each of the impact areas.

In some examples, each of the sixteen impact areas that are analyzed are weighted equally by the lifecycle analyzer 122. For example, all sixteen impacts may be aggregated and balanced against each other in terms of importance through a normalization and weighting procedure. In some examples, the lifecycle analyzer 122 adjusts the weights of various factors in order to emphasize or deemphasize one or more impact areas. In other examples, one or more particular impact areas may be referenced and weighted more heavily than others in order to avoid any backsliding due to one particular impact area. This enables a single impact area, such as a carbon footprint, to have a heavier weight than the other impacts. Where all impact areas are weighted equally, the overall PEF may show a positive/improved result if several of the other sixteen impact areas improve a small amount, even as one impact area gets worse. Where an organization may have specific goals related to one or more impact areas, such as the carbon footprint, by pulling that impact area out as a separate indicator, such as a fourth key metric, the present disclosure provides a backstop against categorizing a product as more sustainable if one particular impact area is worse. Thus, various examples may pull out one or more impact areas that become a priority, to avoid regression and encourage improvement on that specific impact. For example, a carbon footprint may be pulled out as if completely separate from the first key metric, with equal consideration as the first key metric, the second key metric, and the third key metric as a way to prevent regression on this metric in particular. In other examples, additional key metrics may be included, in addition to or in place of those described herein, to raise the profile of a particular metric in weight with the existing metrics in design decisions, disallowing regression of this or any additional metrics as a condition of designating a new product as having a better sustainability profile.

The formulation analyzer 124 implements a second model, different than the first model, that generates a second key metric associated with a chemical analysis of the new product, i.e., formulation sustainability, based on the ingredients in the new product and their proportion in the finished product. For example, the second key metric is a score for intrinsic environmental safety and human exposure that measures factors including, but not limited to, persistence and biodegradability of the ingredients in the new product, aquatic toxicity of the new product, and so forth. In some examples, the second key metric further evaluates and considers other factors that, if present, penalize the overall score of the second key metric, such as bioaccumulation potential, excess toxicity, subsurface mobility potential.

In some examples, the formulation analyzer 124 utilizes a watch list 117 of ingredients, generated and maintained by the watch list database tool 115, that, while presently acceptable, emerging information suggests the potential for future restrictions or limitations in use and the need for reformulation if included in a new product and/or the packaging of a new product. The watch list 117 may be stored on the data storage device 114 as an example of the data 116. The watch list 117 may include ingredients which have emerging concerns, such as environmental concerns, human health concerns, etc., and may be emerging as a concern to one or more regulators, scientists, and so forth, as well as non-scientific issues including but not limited to negative public perception, supply chain disruption, and so forth. Sources of information used to determine the watch list score of a particular ingredient include, but are not limited to, one or more of scientific papers and conferences, communications from health, regulatory, or legislative bodies, social and news media, and supplier intelligence. In some examples, an ingredient is added to the watch list 117 manually, such as by a scientist or other expert in the field. In other examples, the formulation analyzer 124 automatically adds a particular ingredient to the watch list 117 based on the ingredient having a watch list score greater than a threshold.

In some examples, a watch list score for a particular ingredient ranges from zero to five, where zero represents the least risk and five represents the highest risk. A watch list score of zero indicates minimal risk of regulatory action being taken, and the ingredient is not placed on the watch list 117, as illustrated below in Table 1.

TABLE 1

| Score | Example Reasoning | Estimated Onset (year) |
|---|---|---|
| 0 | Not on watch list | N/A |
| 1 | Ingredient critical to | 5+ |
| | portfolio, vigilance needed | |
| 2 | Minimal scientific study | 3-4 |
| 3 | Health authority investigation | 3-4 |
| 4 | Widespread negative | 1-2 |
| | sentiment/demand | |
| 5 | Regulatory action needed | 1-2 |

As shown in Table 1, a watch list score of one may indicate the ingredient is critical to a portfolio of products and indicates a need for vigilance around the ingredient due to the criticality of the ingredient to the portfolio. A watch list score of two may indicate emerging information of concern, such as a single scientific study, which has not been further analyzed or has been shown by another study to be of highly uncertain or minimal risk of leading to an emerging concern. A watch list score of three may indicate an investigation of the ingredient by a health authority or other attention of similar magnitude. A watch list score of four may indicate widespread negative sentiment and/or demand of the ingredient or other attention of similar magnitude. A watch list score of five may indicate a highest likelihood that regulatory or customer action is anticipated and, accordingly, an impending need to reformulate products to exclude the ingredient. In some examples, ingredients having a watch list score of zero, one, or two may reflect issues not relevant to influence sustainable product design, while ingredients having a watch list score of three, four, or five are applied as a penalty to the second key metric. However, it should be understood that this example is presented for illustration only and should not be construed as limiting. Various examples are possible. For example, watch list scores may be presented as alphabetical scores, such as A, B, C, and so forth, from zero to ten, zero to one hundred, or for any suitable range. In other examples, watch list scores may be presented where zero represents the highest risk and the highest number represents the lowest risk.

The watch list database tool 115 generates the watch list score for a particular ingredient by translating the qualitative assessment for an ingredient to a numeric score. In some examples, the watch list database tool 115 generates the watch list score based on four variables: the likelihood (L) that a change to the product due to the ingredient will be necessary at some time in the future, a timing (T) of the change expected, a breadth of impact across a portfolio of products (P), and a technical complexity to implement the change (C), if and when such a change is needed. The likelihood (L) may have a value of 1, 2, or 3, indicating a low, medium, or high likelihood, respectively. The timing (T) may have a value of 1, 2, 3, or 4, indicating a timing of greater than five years, between 3-5 years, between 1-3 years, or less than one year, respectively. The breadth of impact across the portfolio (P) may have a value of 1, 2, or 3, indicating a low, medium, or high likelihood, respectively. The technical complexity to implement the change (C) may have a value of 1, 2, or 3, indicating a low, medium, or high likelihood, respectively. In various examples, other variables may be added to likelihood, timing, portfolio, and change, and some of the variables may be removed, changed, weighted differently, or expressed with more or less granularity, without departing from the scope of the present disclosure.

The default watch list score (DWLS) is generated by the implementation, by the watch list database tool 115, of a multiple linear model. In one example, the DWLS is equal to aL+bT+cP+dC e, where a, b, c, d, and e are each constants. In some examples, a multiple linear regression model is performed using maximum, minimum, and manual scores to establish the coefficients a, b, c, d, and c. As described herein, the watch list score has a scoring range of 1-5, 1-10, 1-100, or any other suitable range. In the example where the scoring range is 1-5, where L, T, P, and C are each minimum values, DWLS is equal to 1 and where L, T, P, and C are each maximum values, DWLS is equal to 5.

As shown in Table 2 below, a watch list score is generated for each ingredient in a particular formulation. Table 2 illustrates Ingredients 1-8 as ingredients available to use in a formula. Table 2 illustrates scores for each of the four variables, the likelihood (L) that a change to the product due to the ingredient will be necessary at some time in the future, the timing (T) of the change expected, the breadth of impact across a portfolio of products (P), and the technical complexity to implement the change (C), if and when such a change is needed. Table 2 further illustrates a manual score, which is the value used for calibration, a manual range representing an ideal range, the calculated score, and any adjustment considerations. Adjustment considerations are not calculated using the formula for the DWLS and are instead manually added, such as via the user portal 111 on the user interface device 110 or the user portal 138 on the interface 136. In example of Table 2 below, using the multiple linear regression, the DWLS score is equal to 0.769L+0.266T+0.496P+0.095C−0.339. The final watch list score (FWLS) may be equal to the DWLS or the DWLS plus or minus manual adjustments.

TABLE 2

| | | | | | | Manual | | |
|---|---|---|---|---|---|---|---|---|
| | | | | | | Score | | |
| | | | | | Manual | (Ideal | Calculated | Adjustment |
| | L | T | P | C | Score | Range) | Score | Considerations |
| Ingredient 1 | 3 | 2 | 2 | 3 | 4 | 4-5 | 4 | |
| Ingredient 2 | 2 | 2 | 2 | 2 | 4 | 3-4 | 3 | |
| Ingredient 3 | 3 | 1 | 3 | 3 | 3 | 3 | 4 | Regional - |
| | | | | | | | | Region X |
| Ingredient 4 | 1 | 1 | 3 | 3 | 2 | 2-3 | 2 | |
| Ingredient 5 | 2 | 2 | 2 | 3 | 3 | 3 | 3 | |
| Ingredient 6 | 1 | 1 | 2 | 1 | 2 | 2 | 2 | |
| Ingredient 7 | 3 | 3 | 2 | 2 | 3 | 3-4 | 4 | |
| Ingredient 8 | 3 | 1 | 3 | 3 | 5 | 5 | 4 | EU Regulation |
| | | | | | | | | imminent with |
| | | | | | | | | expected Global |
| | | | | | | | | follow on |
| Maximum | 3 | 4 | 3 | 3 | 5 | 5 | 5 | |
| Minimum | 1 | 1 | 1 | 1 | 1 | 1 | 1 | |

As described herein, the formulation analyzer 124 implements the second model to generate the second key metric for a product. The formulation analyzer 124 generates a base score that integrates values for factors including, but not limited to, persistence/biodegradability of the product, bioaccumulation potential of the product, aquatic toxicity of the product, “excess” toxicity, e.g., typically environmental endocrine disruption, of the product, if any, subsurface mobility potential of the product, and any other unique or unusual, known environmental safety concern of the product not captured by the metric already. The second key metric is generated on a scale of zero to ten, zero to one hundred, or any other suitable scale. The second key metric may further be adjusted based on a bonus, such as the product's value of a renewable origin index, or a penalty, such as the FWLS. In some examples, the product's value of a renewable origin index is a value between zero and one that is calculated as % w/w organic ingredients derived from biobased feedstocks divided by the total % w/w organic ingredients in the formula, and then multiplied by a weighting factor, for example, ten. Accordingly, the initial second key metric may be adjusted by a maximum increase of ten points and/or a maximum decrease of ten points in order to generate a final second key metric. As referenced herein, a feedstock refers to an origin of chemical precursor used to manufacture a raw material.

The packaging analyzer 126 implements a third model, different than the first and second models, respectively, that generates a third key metric associated with the packaging of the new product. The third key metric is a score that measures the sustainability of packaging of the new product, i.e., packaging sustainability, based on a plurality of impact areas. This provides a holistic view of the sustainability of the packaging of a new product with an emphasis of the recyclability of the packaging of the new product and the amount of virgin plastic used in the packaging of the new product. In some examples, the impact areas that emphasize the recyclability of the packaging of the new product and the amount of virgin plastic used in the packaging of the new product include weight of the packaging that includes post-consumer recycled (PCR) materials or content, material efficiency of the packaging, recycle readiness of the packaging, and the presence or absence of materials that are considered recyclability disruptors, which are flagged as to be avoided in the packaging. The packaging may include a bottle, a wrapper, a box, and so forth in which the new product is distributed and received by a consumer. The packaging may further include branding, formulation information, data required for regulatory or compliance purposes, direction for use, and so forth. In some examples, the third key metric further analyzes tertiary packaging of the new product, which is the packaging used to deliver a product. For example, multiple versions of the new product are shipped from a manufacturer to a distributor to a retailer in a corrugated cardboard box, which is the tertiary packaging. As referenced herein, the third key metric is based on current industry standards and best practices, informed by internal experts and external authorities.

The SIP score generator 128 generates a comprehensive score, also referred to as a sustainability score or a comprehensive sustainability score, based on the first key metric, the second key metric, and the third key metric. In some examples, the SIP score generator 128 includes additional key metrics in the comprehensive score. In some examples, the SIP score generator 128 generates a comparison of each respective metric to an individual threshold for each respective metric, and then compares the outcomes of the comparisons to a target, or goal, to ensure simultaneous compliance with sustainability targets as measured using different sustainability measurement lenses simultaneously. In some examples, the comprehensive score is the sum of the first key metric, the second key metric, the third key metric, and any additional optional key metrics. In some examples, the comprehensive score is the average of the first key metric, the second key metric, the third key metric, and any additional optional key metrics. In some examples, the first key metric, the second key metric, the third key metric, and any additional optional key metrics are weighted so that elements having greater relative importance have a greater effect on the comprehensive score. For example, where one element, e.g., the packaging, is deemed to be of greater importance in the overall comprehensive score, the third key metric is weighted higher than the remaining metrics.

In some examples, the comprehensive score is numerical, such as a value between zero and five, zero and ten, zero and one hundred, and so forth. In other examples, the comprehensive score is expressed as a relative improvement, such as excellent, good, same, poor, or very poor, based on the comparison of the new product to the designated baseline product. In other examples, the comprehensive score is expressed as an outcome of the new product relative to the designated baseline product, such as more sustainable, the same level of sustainable, or not more sustainable. In some examples, for a given new product, each key metric is evaluated against its own threshold and the new product is then determined to be more sustainable, less sustainable, or similar in sustainability by determining whether all thresholds in all metrics are achieved, as shown in Table 3 below.

For example, Table 3 below illustrates an example of how key metrics may be compared to individual thresholds to determine whether minimum improvement targets in sustainability have been achieved or whether regression in sustainability from the baseline has occurred.

TABLE 3

| | Scores compared to baseline product | | | |
|---|---|---|---|---|
| | First key | Second key | Third key | Fourth key |
| | metric | metric | metric | metric |
| Excellent | 20+% | 10+ point | 20+ point | 20+% improvement |
| | improvement | improvement | improvement | |
| Good | 10% to <20% | 5 to <10 point | 10 to <20 point | 10% to <20% |
| | improvement | improvement | improvement | improvement |
| Same | 10% improvement | <5 point | <10 point | 10% improvement |
| | to <10% | regression | improvement | to <10% |
| | regression | to <5 point | to 0 point | regression |
| | | improvement | improvement | |
| Poor | 20% to <10% | <10 to 5 point | <20 point | 20% to <10% |
| | regression | regression | regression | regression |
| Very | 20+% | 10+ point | 20+ point | 20+% |
| Poor | regression | regression | regression | regression |

In some examples, the SIP score generator 128 evaluates the new product using the key metrics. For example, the SIP score generator 128 may evaluate the new product in view of a baseline product. The baseline product includes at least a first baseline metric, a second baseline metric, a third baseline metric, and a baseline comprehensive score that correspond to the first key metric, the second key metric, the third key metric, and a comprehensive score, respectively. Thus, the SIP score generator 128 evaluates the new product by at least one of comparing either each the comprehensive score to a baseline comprehensive score of the baseline product, or by comparing a first baseline metric with the first key metric, a second baseline metric with the second key metric, and a third baseline metric with the third key metric, to evaluate the sustainability of the new product.

In some examples, the SIP score generator 128 generates a sustainability report that including the evaluation of the available metrics, including the first key metric, the second key metric, the third key metric, additional metrics where applicable, and the comprehensive score. The generated sustainability report including an analysis of each key metric as well as the comprehensive score, including an analysis detailing the reasoning behind the score for each key metric and the comprehensive score.

The recommendation generator 130 generates one or more recommendations for increasing the score of any or all of the metrics or the comprehensive score. For example, the recommendation generator 130 implements one or more algorithms and/or machine learning or large language models that recommend changes that can be made to the new product design to improve the sustainability without loss of functionality. In some examples, the recommendation guides design changes that improve sustainability, maintain functionality, and maintain or improve other criteria which can include production costs, extended produce responsibility (EPR) fees, supply chain resilience, or other criteria.

In one example, the recommendation generator 130 generates (1) a matrix of 3 life cycle stage values for each of the 16 indicators for each ingredient in a formulated product, e.g., for a product with 20 ingredients, this consists of 960 values contributing the product's sustainability score due to the formula, (2) a matrix of 6 life cycle stage values for each of the 16 indicators for each material of the primary or secondary packaging in a product, e.g., for a product with a bottle, cap, label, and outer carton this consists of 384 values contributing to the product's sustainability score due to the primary and secondary packaging, and (3) a matrix of 10 life cycle stage values for each of the 16 indicators for each material of the tertiary packaging used to deliver a product, e.g., for a product delivered via corrugated cardboard box this consists of 160 values contributing to the product's sustainability score due to the tertiary packaging. In this example, typical of a commercial formulated cosmetic product, the sustainability score result consists of 1344 numeric values characterizing the impacts of the product, organized by product material, life cycle stage, and impact indicator.

In a first example, the recommendation generator 130 uses a numeric method to identify the product materials that have the largest impact or impacts on the values of the first key metric, the second key metric, the third key metric, and additional metrics, where available, and the sustainability score, identify the life cycle stage at which those impacts occur, and present the results on the user interface device 110 and/or the interface 136. In some examples, the results that are presented include the top three ingredients and one packaging material contributing most to the sustainability score. This may be used to identify which materials should be reduced in the new product and/or replaced with different materials that have a better quantitative sustainability score result.

In a second example, the recommendation generator 130 implements a combination of the first example and additional data describing the function that the most impactful materials of the new product perform in the product, such as a surfactant or other material. In this example, the recommendation generator 130 identifies the most impactful materials and searches an index, such as a database stored as data 116 in the data storage device 114, to identify other materials that may serve the same function, but that have a have a better quantitative sustainability score, and recommends the new material as a substitute.

In a third example, the recommendation generator 130 implements machine learning and/or large language models to extensively search databases of legacy product designs to improve updates to the product design. In this example, the recommendation generator 130 identifies the function of the most impactful product materials as in the first method. However, it is understood that a function served by one product material is contingent on the inclusion of other materials. For example, ultraviolet filters in sunscreens are required to be used in combination to optimize wavelengths of ultraviolet light absorbance to encompass the entire range relevant for protecting skin. To enable better suggestions for improving the sustainability of the new product design, the recommendation generator 130 identifies similar products in a portfolio of existing products, identify combinations of materials that together serve the intended function of the materials in the new product having the highest quantitative sustainability score, and suggest at least one new combination of materials from an existing product with a superior sustainability score result as a potential replacement in the new product design.

It should be understood that although described herein as a first example, a second example, and a third example, these examples should not be construed as limiting. Various examples are possible. Elements of the first example, second example, and third example may be omitted, combined, performed out of order, or otherwise performed in a different order than as described herein, without departing from the scope of the present disclosure.

In some examples, the generated sustainability report further includes the generated recommendations for increasing the score of any or all of the metrics or the comprehensive score. In some examples, each metric has a recommendation for increasing the score. In other examples, only metrics that have a score below a threshold level have a recommendation for increasing the score.

Table 4 below illustrates an example of the different new product designs. The details included in Table 4 may be included in the generated sustainability report for New Product Design 1, New Product Design 2, New Product Design 3, or each of the new products. For example, the generated sustainability report may include scores and outcomes for multiple new products, such as New Product Design 1, New Product Design 2, and New Product Design 3, that each use the same designated baseline product as the baseline for comparison.

TABLE 4

| | Scores compared to baseline product | | | | |
|---|---|---|---|---|---|
| | First key | Second key | Third key | Fourth key | |
| | metric | metric | metric | metric | Outcome |
| New | 16% improvement | 1 point | 1 point | 5% improvement | Pass |
| Product | (Good) | improvement | improvement | (Same) | |
| Design 1 | | (Same) | (Same) | | |
| New | 16% improvement | 15 point | 1 point | 5% improvement | Fail |
| Product | (Good) | regression | improvement | (Same) | |
| Design 2 | | (Very Poor) | (Same) | | |
| New | 6% improvement | 1 point | No change | 5% improvement | Fail |
| Product | (Same) | improvement | (Same) | (Same) | |
| Design 3 | | (Same) | | | |

The product design updater 132 triggers an update to the new product based on the recommendation generated by the recommendation generator 130. In some examples, triggering the update to the new product includes transmitting instructions to the external device 134 and/or the server 140 with changes to the design of the new product based on the generated recommendation. In other examples, triggering the update to the new product includes presenting the instructions for changes to the design of the new product based on the generated recommendation on the user interface device 110.

The external device 134 is another example of a computing device, separate from and external of the computing device 102. In some examples, the external device 134 includes a mobile computing device or any other portable device. A mobile computing device includes, for example but without limitation, a mobile telephone, laptop, tablet, computing pad, netbook, gaming device, and/or portable media player. The external device 134 can also include less-portable devices such as servers, desktop personal computers, kiosks, or tabletop devices. Additionally, the external device 134 can represent a group of processing units or other computing devices. The external device 134 includes an interface 136 and a user portal 138 implemented on the interface 136. The interface 136 may be another example of the user interface device 110 and the user portal 138 may be another example of the user portal 111.

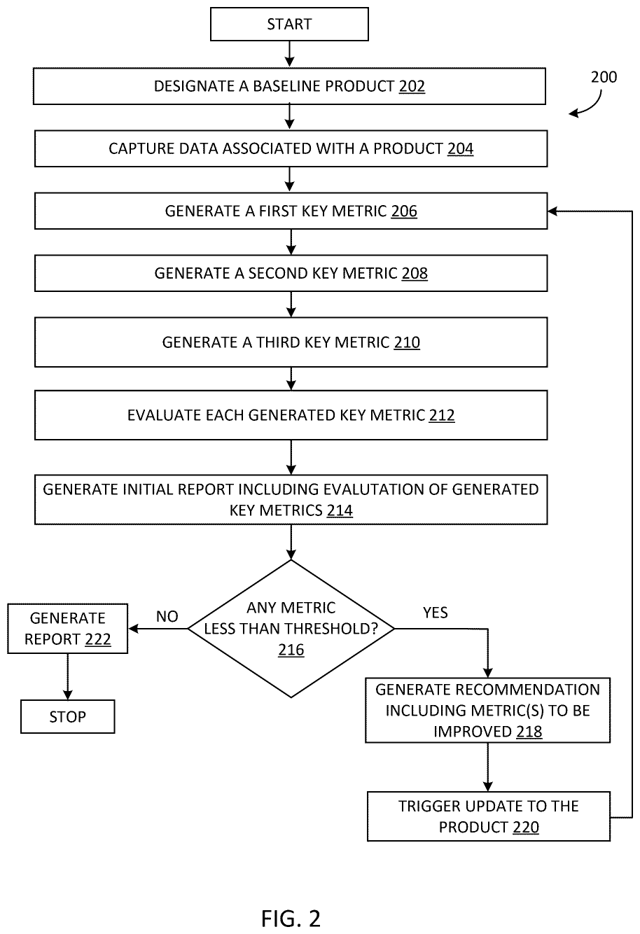

FIG. 2 illustrates an example computer-implemented method of profiling sustainability of an innovation according to an example. The computer-implemented method 200 is presented for illustration only and should not be construed as limiting. Other examples of the computer-implemented method 200 can be used without departing from the scope of the present disclosure. The computer-implemented method 200 can be implemented by one or more electronic devices described herein, such as the computing device 102.

The method 200 begins by the baseline product designator 119 designating a baseline product in operation 202. The baseline product designator 119 designates an appropriate baseline product that ensures validity of the evaluation of a new product and documents the method of baseline determination in order to maintain consistency between evaluations of different new products. The designated baseline product includes baseline data, including formulation data, packaging data, and so forth, as well as a first baseline metric, a second baseline metric, and a third baseline metric and additional metrics where applicable.

In some examples, the baseline product designator 119 designates a baseline product based on a series of factors, including but not limited to, whether the new product is a revised version of an existing product and will be marketed for the same main consumer benefit, whether the new product will cannibalize sales of the existing product, whether new products have an existing predecessor, the prevalence of potential baseline products, the recency of the design of potential baseline products, and so forth. For example, where the new product will be a revised version of an existing product and will be marketed for the same main consumer benefit, the baseline product designator 119 designates the existing version currently marketed as the baseline product. Where the new product does not have a clear predecessor, the baseline product designator 119 may identify, within an index of the current products in the portfolio, a product with a similar consumer benefit that is the same or very close to the same as the new product and designate such product as the baseline product. In some examples, a new product may have multiple options for a potential baseline product. Here, various examples are possible. In some examples, the baseline product is selected as the one that is most prevalent on the market, such as the product having the greatest sale volume. In other examples, the baseline product is selected as the one having the closest formula to the new product. In other examples, the baseline product is selected as the one that was most recently designed. In other examples, multiple baseline products may be selected for comparison to the new product.

In operation 204, the data hub 118 captures data associated with a new product. In some examples, capturing the data includes pulling data 116 from the data storage device 114. The data 116 may include, but is not limited to, finished goods specifications, packaging component specifications, bill of materials, connected product data, enterprise data sources such as composition, rules engine, product specification, and project/planning information of which the new product is included. Composition includes the formula for the product, raw material data, and chemicals. In some examples, a raw material is manufactured from petrochemical or bio-based, renewable carbon feedstocks, while data on chemicals are supplier-independent, including but not limited to the biodegradability or aquatic toxicity of the chemical. In various examples, raw materials may be a single chemical or a blend of chemicals. The rules engine includes any rules associated with the new product, such as whether any ingredients are included in the watch list 117, if so, what the watch list score is, recyclability of the new product, and so forth. The connected product data includes, but is not limited to, a formula, a packaging bill of materials, and a product, such as a barcode, SAP point of sales code, and so forth, together for a particular product.

The data 116 may further include additional data sources, including but not limited to assumptions, parameters, confirmed assumptions, and so forth. Assumptions may include a segment of the portfolio the new product will fill, anticipated consumption of the new product, a mixture of power sources used to manufacture the new product, for example coal, gas, solar, hydroelectric, and so forth, proximity of the manufacturing from distribution, and so forth. Parameters may include various thresholds the new product is anticipated to meet, including but not limited to minimum post-consumer recycled content for packaging; minimum renewable feedstock for chemical constituents of the formula, and so forth that are based on the use of preferred or acceptable ingredients in packaging.

In operation 206, the lifecycle analyzer 122 generates the first key metric for the new product. As described herein, the first key metric measures the environmental impact of the new product based on a plurality of impact areas, including but not limited to ecosystems affected by the new product, human health affected by the new product, the effect the new product may have on climate change, natural resources that may be affected by the new product, and the effect of the new product on water.

In operation 208, the formulation analyzer 124 generates the second key metric for the new product. As described herein, the second key metric is a chemical analysis of the new product based on the ingredients in the new product and their proportion in the finished product. The second key metric measures factors including, but not limited to, persistence and biodegradability of the ingredients in the new product, aquatic toxicity of the new product, and so forth, as well as incorporating opportunities to increase, as a bonus, or decrease, as a penalty, the second key metric.

In operation 210, the packaging analyzer 126 generates the third key metric for the new product. As described herein, the third key metric measures impact areas including weight of the packaging that includes PCR materials or content, material efficiency of the packaging, recycle readiness of the packaging, and the presence or absence of materials that are considered ‘recyclability disruptors' and are therefore to be avoided in the packaging. The third key metric determines the impact of design changes that directly influence sustainability and that are widely recognized and commonly reported publicly to demonstrate more sustainable packaging design.

It should be understood that although operations 206-210 are illustrated in FIG. 2 as occurring in sequence, various examples are possible. In various examples, operations 206-210 may occur in a different order than illustrated in FIG. 2 or may occur simultaneously without departing from the scope of the present disclosure. In other words, operation 206 may occur prior to, at the same time as, or following operations 208 and 210, operation 208 may occur prior to, at the same time as, or following operations 206 and 210, and operation 210 may occur prior to, at the same time as, or following operations 206 and 208.

In operation 212, the SIP score generator 128 evaluates each of the generated key metrics, i.e., the first key metric, the second key metric, the third key metric, and additional metrics, where applicable. For example, the SIP score generator 128 evaluates the new product in view of the designated baseline product. In other words, the SIP score generator 128 evaluates the new product by comparing the first baseline metric with the first key metric, the second baseline metric with the second key metric, the third baseline metric with the third key metric, and additional baseline metrics, where applicable, with the corresponding additional key metrics to evaluate the sustainability of the new product.

It should be understood that although operation 212 is illustrated in FIG. 2 as occurring in sequence with operations 206-210, various examples are possible. In various examples, operation 212 may occur immediately after operation 206, immediately after operation 208, and/or immediately after operation 210 without departing from the scope of the present disclosure. For example, a particular key metric may be evaluated immediately after it is generated and before a different key metric is generated.

In operation 214, the SIP score generator 128 generates a comprehensive sustainability score for the new product and a sustainability report of the new product that includes the comprehensive sustainability score. The comprehensive sustainability score is based on the evaluations of the first key metric, the second key metric, the third key metric, and additional metrics, where applicable. The comprehensive score may be generated based on various different methodologies. In some examples, the comprehensive score is the sum of the first key metric, the second key metric, the third key metric, and additional metrics, where applicable. In some examples, the comprehensive score is the average of the first key metric, the second key metric, the third key metric, and additional metrics, where applicable. In some examples, the first key metric, the second key metric, the third key metric, and additional metrics, where applicable, are weighted so that elements having greater relative importance have a greater effect on the comprehensive score. For example, where one element, e.g., the packaging, is deemed to be of greater importance in the overall comprehensive score, the third key metric is weighted higher than the other metrics.

In operation 216, the SIP score generator 128 determines whether any of the first key metric, the second key metric, the third key metric, and other, additional metrics or scores are less than a threshold. In some examples, the threshold is a measure of first key metric, the second key metric, the third key metric, and other, additional metrics or scores to the baseline product. For example, as shown in Table 3, each of the first key metric, the second key metric, the third key metric, and fourth key metric are assigned a rating of excellent, good, same as, poor, or very poor relative to the baseline product. The threshold may be set at “same as”, “good”, or “excellent” based on what the new product is, a sustainability score of the baseline product, the anticipated sales volume of the product, or any other suitable factor or combination of factors. For example, where the baseline product has a high sustainability score, the threshold may be set as “same as” because a new product having a same sustainability score will also be a sustainable product. However, where the baseline product has a low sustainability score, the threshold may be set as “good” or “excellent” because it is desirable for a new product to have a greatly improved sustainability score relative to the baseline product.

In some examples, the analysis of each of the first key metric, the second key metric, the third key metric, and other, additional metrics or scores relative to the baseline product are weighted equally. For example, where the SIP score generator 128 determines that any one of the first key metric, the second key metric, the third key metric, other, additional metrics or scores is less than the threshold, the SIP score generator 128 proceeds to operation 218 and generates a recommendation for improving the metric or score to be improved. In other examples, the SIP score generator 128 focuses the analysis on only a select factor or factors, rather than each of the first key metric, the second key metric, the third key metric, other, additional metrics or scores to the baseline product.

In yet other examples, the SIP score generator 128 implements a blended threshold for the analysis performed in operation 216. In other words, the SIP score generator 128 may implement an independent threshold for the analysis of each of the first key metric, the second key metric, the third key metric, and other, additional metrics or scores to the baseline product. For example, the threshold used for the first key metric is “good”, the threshold used for the second key metric is “excellent”, the threshold used for the third key metric is “good”, and the threshold used for the comprehensive score is “same”. In yet other examples, the SIP score generator 128 implements a blended analysis of the first key metric, the second key metric, the third key metric, and the comprehensive sustainability score to the baseline product, such that at least one key metric or comprehensive sustainability score is “good” and none of the first key metric, the second key metric, the third key metric, and the comprehensive sustainability score to the baseline product has a score of “poor” or “very poor”, indicating that both i) at least one element of the new product is an improvement over the baseline product, and ii) the overall sustainability of the new product is at least the same as, and ideally an improvement in some way, over the baseline product.

In examples where the SIP score generator 128 determines at least one of the first key metric, the second key metric, the third key metric, and other, additional metrics or scores relative to the baseline product is less than the threshold, the method 200 proceeds to operation 218 and generates a recommendation for improving the metric or score to be improved. For example, the recommendation generator 130 generates a recommendation for improving the for increasing the score of any or all of the metrics or the comprehensive score. In some examples, the recommendation includes recommended changes that can be made to the new product design to improve the sustainability, maintain functionality, and maintain or improve other criteria which can include production costs, extended producer responsibility fees, supply chain resilience, or other criteria without loss of functionality.

In operation 220, the product design updater 132 triggers an update to the new product based on the generated recommendation. Following the triggering of the update to the new product, the method returns to operation 206 and the lifecycle analyzer 122 generates the first key metric for the updated new product.

In examples where, in operation 216, the SIP score generator 128 determines none of the first key metric, the second key metric, the third key metric, or other, additional metrics or scores to the baseline product are less than the threshold, the method 200 proceeds to operation 222. In operation 222, the recommendation generator 130 generates a report recommending no additional changes to the design of the new product. The report is output on one or more of the user interface device 110 or the interface 136. Following the report being output, the method 200 terminates.

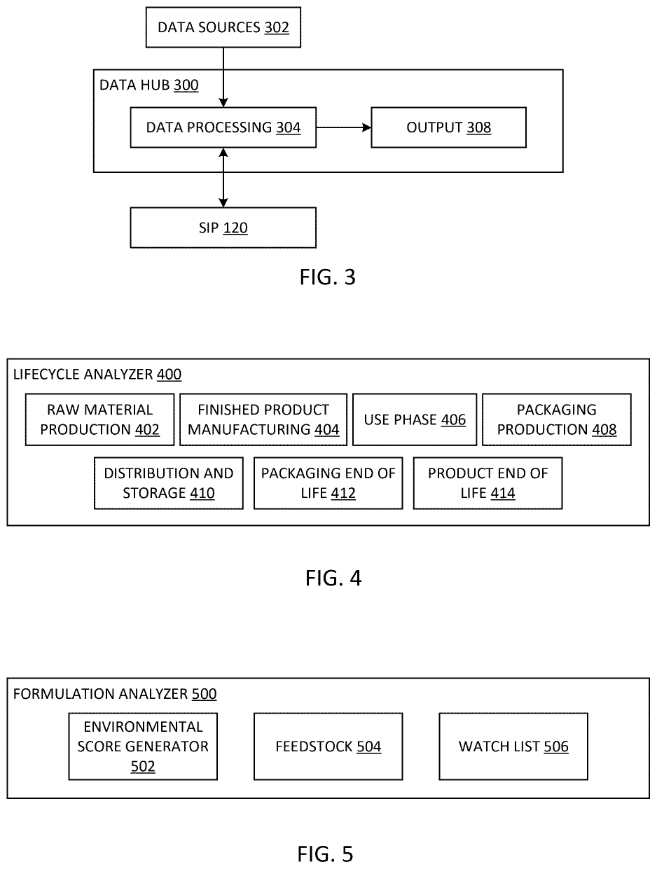

FIG. 3 illustrates an example data hub system according to an example. The data hub 300 illustrated in FIG. 3 is provided for illustration only. Other examples of the data hub 300 may be used without departing from the scope of the present disclosure. In some examples, the data hub 300 aggregates and processes data associated with an innovation in order to recommend and trigger product design changes to increase the sustainability of the innovation according to one or more examples described herein.

In some examples, the data hub 300 is an example of the data hub 118 illustrated in FIG. 1. As referenced herein, the data hub 300, also referred to as a sustainability data hub, is a specialized processing unit, or units, executed on the processor 108 that performs various data related functions, including data collection, data processing, data cataloging, and transmission of data via an enterprise data highway. In some examples, the data hub 300 pulls and aggregates data from one or more data sources 302. Various examples of data sources 302 include, but are not limited to, finished goods specifications, packaging component specifications, bill of materials, connected product data, enterprise data sources such as composition, rules engine, product specification, and project/planning information of which the new product is included. Composition includes the formula for the product, raw material data, and chemicals. In some examples, a raw material is manufactured from petrochemical or bio-based, renewable carbon feedstocks, while data on chemicals are supplier-independent, including but not limited to the biodegradability or aquatic toxicity of the chemical. In various examples, raw materials may be a single chemical or a blend of chemicals. The rules engine includes any rules associated with the new product, such as whether any ingredients are included in the watch list 117, if so, what the watch list score is, recyclability of the new product, and so forth. The connected product data includes, but is not limited to, a formula, a packaging bill of materials, and a product, such as a barcode, SAP point of sales code, and so forth, together for a particular product. The data sources 302 may further include but not limited to assumptions, parameters, and so forth. Assumptions may include a segment of the portfolio the new product will fill, anticipated consumption of the new product, a mixture of power sources used to manufacture the new product, for example coal, gas, solar, hydroelectric, and so forth, proximity of the manufacturing from distribution, and so forth. Parameters may include various thresholds the new product is anticipated to meet, including but not limited to minimum post-consumer recycled content for packaging; minimum renewable feedstock for chemical constituents of the formula, and so forth that are based on the use of preferred or acceptable ingredients in packaging. In some examples, the data pulled from the data sources 302 is stored in the data storage device 114 as examples of the data 116.

The data hub 300 further includes data processing 304. In some examples, the data processing transforms the pulled and aggregated data into a standardized format so that one or more aspects of the SIP 120, such as the lifecycle analyzer 122, the formulation analyzer 124, the packaging analyzer, 126, and so forth, are able to perform their respective functions. For example, the variety of data sources 302 may collect, store, and provide the data to the data hub 300 in different sources, formats, and so forth. Thus, the data from the data sources 302 is processed into a standardized format in order to be utilized by the SIP 120.

Upon the data processing 304 standardizing the format of the collected data from the data sources 302, the SIP 120 executes the series of models to analyze a different aspect of the new product to generate respective scores regarding the new product as described herein. In some examples, following the various scores being generated by the SIP 120, the scores are collected and transmitted back to the data hub 300 for processing. For example, the generated scores are converted to an output format suitable for outputting the generated scores, depending on how the generated scores are to be presented.

The output 308 of the SIP 120 is output to one or more of a data product, an internal database, or an external database. For example, the output may be stored in an internal or external database or output to an application, such as an application 107 or an application on an external device, such as the external device 134, for presentation to a user. The database may be stored in the data storage device 114 or the server 140 in order to catalog data 116, including but not limited to the generated scores, to make the data 116 available to other aspects of an organization or enterprise, as metadata that identifies the data, how the data is stored, how to access the data, and so forth. In some examples, the generated scores are output to the data storage device 114, or an external storage device such as the server 140, as data 116 that can be pulled and presented in response to a query. For example, a query presented via the user portal 111 may ask whether there are any green chemical issue that could affect the end of life for a particular product. The generated score from the formulation analyzer 124 may be pulled from the data storage device 114 and presented as the response, or part of the response, to the query.

FIG. 4 illustrates an example lifecycle analyzer system according to an example. The lifecycle analyzer 400 illustrated in FIG. 4 is provided for illustration only. Other examples of the lifecycle analyzer 400 may be used without departing from the scope of the present disclosure. In some examples, the lifecycle analyzer 400 generates a first key metric associated with the sustainability of the lifecycle of a new product according to one or more examples described herein.

In some examples, the lifecycle analyzer 400 is an example of the lifecycle analyzer 122 illustrated in FIG. 1. As referenced herein, the lifecycle analyzer 400 implements a first model that generates a first key metric associated with an environmental impact of a new product based on a plurality of impact areas. For example, various impact areas include, but are not limited to, ecosystems affected by the new product, human health affected by the new product, the effect the new product may have on climate change, natural resources that may be affected by the new product, and the effect of the new product on water. The analysis of ecosystems affected by the new product includes separate analysis of acidification, terrestrial eutrophication, freshwater cutrophication, marine cutrophication, and freshwater ecotoxicity. The analysis of how human health may be affected by the new product includes separate analysis of ozone depletion, human toxicity including cancer effects, human toxicity including non-cancer effects, particulate matter, ionizing radiation, and photochemical ozone formation. The analysis of climate change includes an analysis of the new product on global warming. The analysis of natural resources that may be affected by the new product includes an analysis of mineral resource depletion, non-renewable energy resource depletion, and land use. The analysis of the effect of the new product on water includes an analysis of the water scarcity footprint due to the new product. As described in greater detail below, the lifecycle analyzer 400 generates the first key metric based on the analysis of each of the impact areas.

The lifecycle analyzer 400 analyzes the various impact areas of each component of a new product in seven phases of the new product, including but not limited to raw material product 402, finished product manufacturing 404, use phase 406, packaging production 408, distribution and storage 410, packaging end of life 412, and product end of life 414. In other words, each impact area of each element of the new product is analyzed for all seven phases of the product lifecycle. For example, a new product containing a formulation and packaging will include an analysis of each impact area of each ingredient in the formulation as well as each impact area of the packaging.

The raw material production 402 is an analysis of the raw materials included in the component of the new product. The finished product manufacturing 404 is an analysis of the component in the manufacturing of the finished new product. The use phase 406 is an analysis of the use of the new product by a consumer following production and purchase. The packaging production 408 is an analysis of manufacturing each packaging component in the new product. The distribution and storage 410 is an analysis of the distribution and the storage of the new product and the role of the component in such. The packaging end of life 412 is an analysis of the end of life of the packaging of the new product, i.e., whether the packaging is disposed of, biodegraded, and so forth, and the role of the component in such. The product end of life 414 is an analysis of the end of life of the new product, i.e., whether and how the new product is disposed of, biodegraded, digested, and so forth, and the role of the component in such. In some examples, one or more of the raw material product 402, finished product manufacturing 404, use phase 406, packaging production 408, distribution and storage 410, packaging end of life 412, and product end of life 414 may be provided by an external tool, such as an application implemented on the external device 134, that implements the analysis of the specific aspect of the component of the packaging of the new product.

FIG. 5 illustrates an example formulation analyzer according to an example. The formulation analyzer 500 illustrated in FIG. 5 is provided for illustration only. Other examples of the formulation analyzer 500 may be used without departing from the scope of the present disclosure. In some examples, the formulation analyzer 500 generates a second key metric associated with the sustainability of a new product according to one or more examples described herein.

In some examples, the formulation analyzer 500 is an example of the formulation analyzer 124 illustrated in FIG. 1. As referenced herein, the formulation analyzer 500 implements a second model, different than the first model, that generates the second key metric associated with a chemical analysis of the new product based on the ingredients in the new product and their proportion in the finished product. For example, the second key metric is a score for intrinsic environmental safety and human exposure that measures factors including, but not limited to, persistence and biodegradability of the ingredients in the new product, aquatic toxicity of the new product, and so forth. In some examples, the second key metric further evaluates and considers other factors that, if present, penalize the overall score of the second key metric, such as bioaccumulation potential, excess toxicity, and subsurface mobility potential.

The formulation analyzer 500 includes an environmental score generator 502. The environmental score generator 502 generates the second key metric for each ingredient in the new product based on one or more of environmental persistence, bioaccumulation through the food chain, and direct toxicity to an aquatic organism. In some examples, the second key metric is provided as a numerical score, such as a value between zero and five, zero and ten, zero and one hundred, and so forth. In other examples, the second key metric is expressed as a relative improvement, such as excellent, good, same, poor, or very poor, based on the comparison of the new product to the designated baseline product. In other examples, the second key metric is expressed as an outcome of the new product relative to the designated baseline product, such as more sustainable, the same level of sustainable, or not more sustainable. In examples where the second key metric is expressed as a numerical score, a low second key metric indicates that the ingredient has a potentially negative impact on the environment and a high second key metric indicates that the ingredient does not have a potentially negative impact on the environment. In some examples, the environmental score generator 502 generates a primary second key metric for each ingredient, and generates a secondary second key metric for the new product as a whole. The secondary second key metric may be generated as an average of each primary second key metric or based on a weighting of the primary second key metrics.

The feedstock 504 refers to an origin of chemical precursor used to manufacture a raw material in the formulation. The raw materials that are carbon based have carbon originating from either or both of a non-renewable, e.g., petrochemical, source or from a renewable, e.g., bio-based, source. Bio-based sourced are preferred in the green chemistry sustainability paradigm, resulting in a bonus by the environmental score generator 502. The bonus for renewable feedstock is calculated as the percent weight of renewable carbon-based ingredients divided by the percent weight of all carbon-based ingredients, multiplied by a weighting factor, such as ten.

The watch list 506 is an example of the watch list 117 described herein. For example, the watch list 506 is an example of horizon scanning and includes one or more ingredients in packaging which may have emerging concerns, such as environmental concerns, human health concerns, etc., and may be identified in the future as an emerging concern to one or more regulators, scientists, and so forth, as well as non-scientific issues including but not limited to negative public perception, supply chain disruption, and so forth. In some examples, the watch list 506 is generated by the watch list database tool 115.

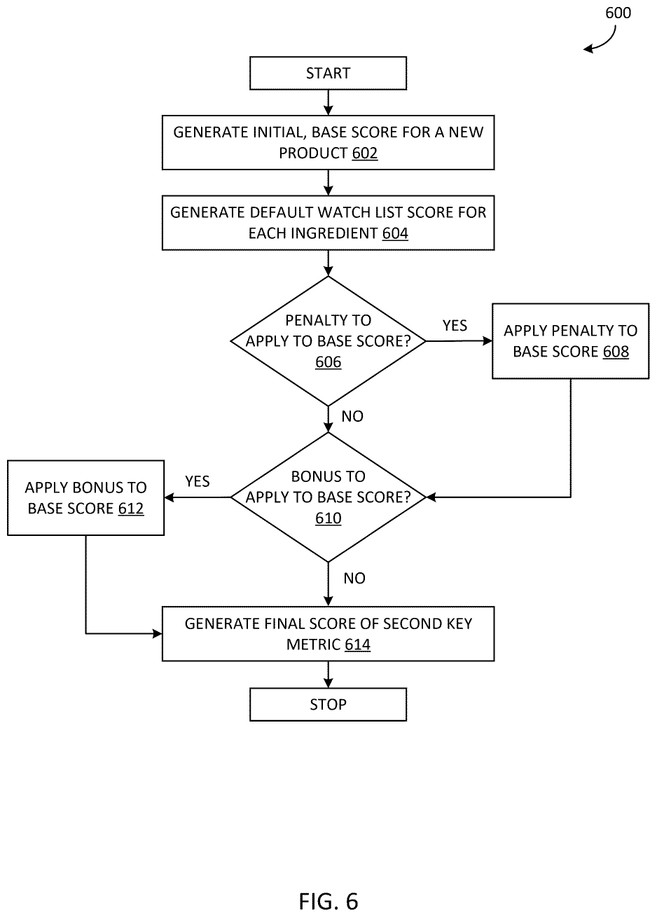

FIG. 6 illustrates an example computer-implemented method of analyzing a formulation according to an example. The computer-implemented method 600 is presented for illustration only and should not be construed as limiting. Other examples of the computer-implemented method 600 can be used without departing from the scope of the present disclosure. The computer-implemented method 600 can be implemented by one or more electronic devices described herein, such as the computing device 102.

The method 600 begins by the formulation analyzer 124 generating an initial, base score for a new product in operation 602. The formulation analyzer 124 implements a model that generates the base score by integrating values for factors including, but not limited to, persistence/biodegradability of the product, bioaccumulation potential of the product, aquatic toxicity of the product, “excess” toxicity, e.g., typically the potential for environmental endocrine disruption, of the product, if any, potential subsurface mobility of the product, and other unique environmental safety concerns not otherwise included, if any are known.

In operation 604, the watch list database tool 115 generates a default watch list score for each ingredient in the new product. As described herein, the watch list database tool 115 generates the watch list score based on four variables: the likelihood (L) that a change to the product due to the ingredient will be necessary at some time in the future, a timing (T) of the change expected, a breadth of impact across a portfolio of products (P), and a technical complexity to implement the change (C), if and when such a change is needed. The four variables are input into a linear model, such as a multiple linear regression model, generate a watch list score for each ingredient in the new product and then a watch list score for the new product based on the scores for each ingredient. In various examples, the default watch list score is generated on a scale of zero to five. The generated default watch list score for each ingredient is sent to the formulation analyzer 124.

In operation 606, the formulation analyzer 124 determines whether or not to apply a penalty to the generated base score. In some examples, the penalty is applied based on the watch list score being above a threshold level, such as three or greater. For example, where the watch list score is 3, 4, or 5, the formulation analyzer 124 applies a penalty to the generated base score in operation 608 to generate an updated score. Following operation 608, the method 600 proceeds to operation 610. In examples where the watch list score is determined to be less than the threshold level, such as 0, 1, or 2, the method 600 proceeds from operation 606 directly to operation 610.

In operation 610, the formulation analyzer 124 determines whether or not to apply a bonus to the generated base score, where no penalty was applied in operation 606, or the updated score, where the penalty was applied in operation 606. In some examples, the bonus is determined as the new product's value of a renewable origin index. The new product's value of a renewable origin index may be a value between zero and one that is calculated as % w/w organic ingredients derived from biobased feedstocks divided by the total % w/w organic ingredients in the formula, and then multiplied by a weighting factor, such as 10. In examples where the formulation analyzer 124 determines to apply the bonus to the generated base score or the updated score, the method 600 proceeds to operation 612 and applies the bonus to the base or updated score. Following the bonus being applied to the base score, the method proceeds to operation 614. In examples where the where the formulation analyzer 124 determines not to apply the bonus to the generated base score or the updated score, the method 600 proceeds to operation 614.

In operation 614, the formulation analyzer 124 generates and outputs the final score based on the initial base score and any potential adjustments made by adding a penalty to the initial base score, adding a bonus to the initial base score, both, or neither. The final score is output, such as on the user interface device 110, the interface 136, or both. In some examples, the final score is output to the SIP generator 128 for use in calculating a comprehensive score and evaluating the new product. Following operation 614, the method 600 terminates.

It should be understood that although illustrated in FIG. 6 as a series of steps, various operations may be added to, removed from, or performed in a different order or by a different mechanism than those illustrated herein without departing from the scope of the present disclosure. For example, throughout its analysis, the formulation analyzer 124 may include measurements or metrics that reflect other aspects of the principles of green chemistry, including, but not limited to, promoting formulations that promote energy efficiency, e.g., by being easier to rinse off, reducing excess, unintended environmental or human exposure, reducing waste, and so forth.

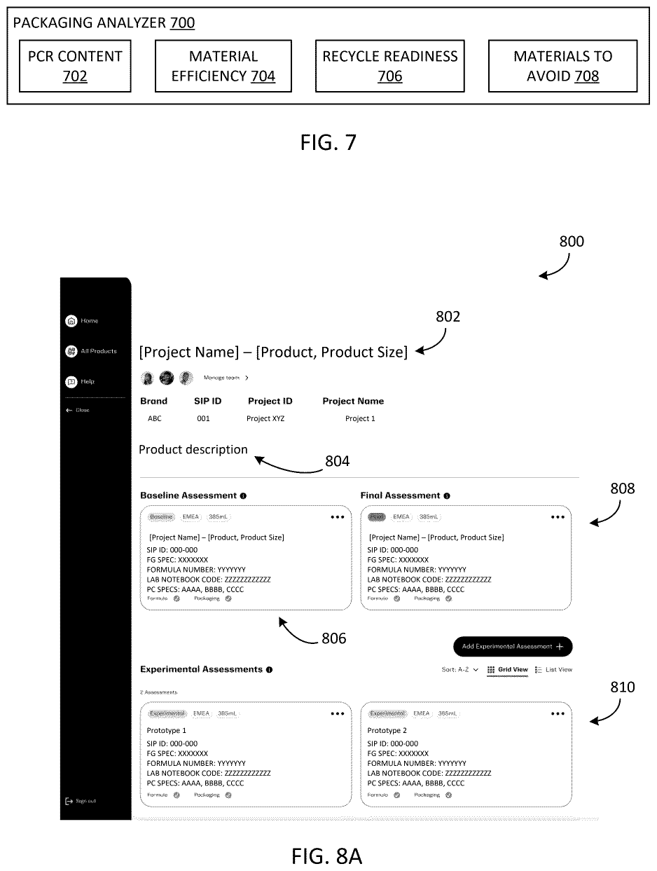

FIG. 7 illustrates an example packaging analyzer according to an example. The packaging analyzer 700 illustrated in FIG. 7 is provided for illustration only. Other examples of the packaging analyzer 700 may be used without departing from the scope of the present disclosure. In some examples, the packaging analyzer 700 generates a third key metric associated with the sustainability of the packaging of a new product according to one or more examples described herein.

In some examples, the packaging analyzer 700 is an example of the packaging analyzer 700 126 illustrated in FIG. 1. As referenced herein, the packaging analyzer 700 implements the third model, different than the first and second models, respectively, to generate the third key metric associated with the packaging of the new product. As shown in FIG. 7, the impact areas include weight of the packaging that includes post-consumer recycled (PCR) materials or content 702, material efficiency 704 of the packaging, recycle readiness 706 of the packaging, and the presence or absence of materials that are considered recyclability disruptors and flagged as to be avoided 708 in the packaging. For example, PCR content 702 is a comparison between the proportion by weight of the packaging that is made from PCR materials between the baseline product packaging and the new product packaging. The material efficiency 704 is a comparison between the packaging weight per functional unit, or dose, in each package between the baseline product packaging and the new product packaging. The recycle readiness 706 is a comparison between proportions by weight of the packaging that is defined as ‘recycle ready’, as per guidelines on current best practices to ensure broad recyclability, which may be generated as manual rules by internal subject matter experts or by one or more elements of the SIP 120, between the baseline product packaging and the new product packaging. The materials to avoid 708 is a determination of whether any materials are present in the packaging that are considered recyclability disruptors and flagged as to be avoided in the packaging. For example, these materials may be included in a list of materials that are considered recyclability disruptors, which is a packaging watch list 117 stored on the data storage device 114 as data 116. In various examples, and as referenced herein, the packaging watch list 117 is a list of packaging materials that are considered to be harmful to the environment or which prevent circularity. The packaging watch list 117 is generated and maintained by the watch list database tool 115 based on a compilation of multiple internal and external resources.

In some examples, points in the PCR content 702 and the recycle readiness 706 may be assigned based on a linear scale. For example, the PCR content 702 may represent a normalized points range, such as −25 to +25, where a comparison is made between the proportion by weight of PCR content in the baseline product packaging and the new product packaging and points are assigned based on the linear scale that caps at 95%, i.e., where greater than 95%=+25 points. Similarly, the recycle readiness 706 may represent a normalized points range, such as −10 to +10, where a comparison is made between the proportion by weight of recycle ready packaging in the baseline product packaging and the new product packaging and where points are assigned based on the linear scale. In some examples, the material efficiency 704 is a comparison of the packaging weight per functional unit or dose between the baseline product packaging and the new product packaging. Packaging may include a normalized points range, such as −15 to +15, where points are assigned based the percentage difference between the baseline and new product packaging on a linear scale which caps at −30% and +30% respectively.

In some examples, the PCR content 702, material efficiency 704, recycle readiness 706 are weighted equally in the generation of the third key metric. In other examples, the PCR content 702, material efficiency 704, recycle readiness 706 are weighted differently to emphasize different aspects to the packaging analysis. For example, fifty percent of the third key metric may be attributed to the PCR content 702, thirty percent of the third key metric may be attributed to the material efficiency 704, and twenty percent of the third key metric may be attributed to the recycle readiness 706. However, other weight percents may be possible without departing from the scope of the present disclosure. Various examples are possible.

The third key metric may be provided as a numerical score, such as a value between zero and five, zero and ten, zero and one hundred, negative fifty to fifty, and so forth. In other examples, the third key metric is expressed as a relative improvement, such as excellent, good, same, poor, or very poor, based on the comparison of the new product to the designated baseline product. In other examples, the third key metric is expressed as an outcome of the new product relative to the designated baseline product, such as more sustainable, the same level of sustainable, or not more sustainable. For example, where the third key metric is provided as a relative improvement between zero and one hundred, the third key metric is provided as “excellent” when the third key metric is an improvement of greater than or equal to twenty points over the baseline product packaging, as “good” when the third key metric is an improvement of greater than or equal to ten points but less than twenty over the baseline product packaging, as “no improvement” when the third key metric is an improvement of less than ten points over the baseline product packaging, as “poor” when the third key metric has a score of between zero and less than or equal to twenty points less than the baseline product packaging, and “very poor” when the third key metric has a score of greater than twenty points less than the baseline product packaging.

In some examples, where the materials to avoid, i.e., recyclability disruptors, 708 determination indicates that at least one material is present in the packaging that is flagged as to be avoided, the third key metric overwrites the additional analyses of PCR content 702, material efficiency 704, and recycle readiness 706 and is generated as “very poor”. This enables a single impact area, such as the presence of a flagged material, to have a heavier weight than the other impact areas and provides a backstop against potentially classifying a packaging as an improvement despite the packaging actually included a flagged material.

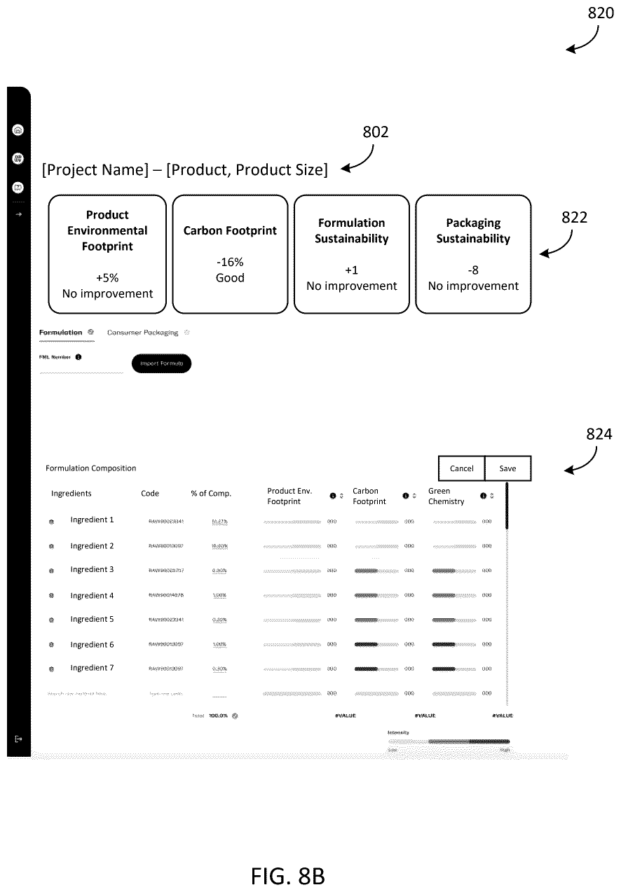

FIGS. 8A-8B illustrate example user interfaces for a sustainable innovation profiler according to an example. The example user interfaces illustrated in FIGS. 8A-8B are provided for illustration only. Other examples of the example user interfaces may be used without departing from the scope of the present disclosure.

FIG. 8A illustrates a first user interface 800. In some examples, the first user interface 800 is presented on the user interface device 110. In some examples, the first user interface 800 is presented as an example of the user portal 111. In some examples, the first user interface 800 is presented on the interface 136. In some examples, the first user interface 800 is presented as an example of the user portal 138.

The first user interface 800 includes project data 802, a product description 804, a baseline assessment 806, a final assessment 808, and one or more experimental assessments 810. The project data 802 includes details regarding the new product that is being analyzed. For example, the project data 802 may include, but is not limited to, a project name, a product name, a size of the product, a project ID, a brand associated with the project, an SIP ID, one or more team members associated with the project, and so forth. The product description 804 includes a description of the new product identified in the project data 802. For example, where the project data 802 indicates a shampoo, the product description 804 may be presented as a “restage of a previous shampoo to improve differentiation and competitiveness within the category”. In some examples, the product description 804 further includes images of the new product, images of the packaging of the new product, videos of the new product, videos of the packaging of the new product, and so forth.

The baseline assessment 806 includes an initial, baseline assessment of the new product identified in the project data 802. In some examples, the baseline assessment 806 is a first assessment of a first iteration of the new product where no comparison product has been designated, to identify aspects of the product contributing most to scores in the key metrics, and to identify targets for design changes independent of baseline. In some examples, the baseline assessment 806 is an assessment of the baseline product identified by the baseline product designator 119. The final assessment 808 is a final assessment of the new product identified in the project data 802. In some examples, each of the baseline assessment 806 and the final assessment 808 include respective versions of the generated scores, including the first key metric, the second key metric, the third key metric, and other, additional metrics or scores, if applicable, as well as product and/or project data such as the SIP ID, formula specification number, lab notebook data, packaging component specification identification, and so forth. The one or more experimental assessments 810 includes hypothetical assessment data based on simulated changes to one or more aspects of the new product, such as changes to one or more ingredients in the formulation of the new product, changes to one or more aspects of the packaging of the new product, and so forth.

In some examples, one or more of the baseline assessment 806, the final assessment 808, and the one or more experimental assessments 810 are presented on the user interface device 110 or the interface 136 as selectable icons. For example, a user may select, either by a touch input, controlling a cursor, or otherwise, one or more of the baseline assessment 806, the final assessment 808, or the one or more experimental assessments 810, upon which a second user interface 820 is presented on the user interface device 110 or the interface 136.

FIG. 8B illustrates the second user interface 820. In some examples, the second user interface 820 is presented on the user interface device 110. In some examples, the second user interface 820 is presented as an example of the user portal 111. In some examples, the second user interface 820 is presented on the interface 136. In some examples, the second user interface 820 is presented as an example of the user portal 138.

The second user interface 820 includes the project data 802, metrics 822, and product details 824. The project data 802 is the same project data 802 presented on the first user interface 800. The metrics 822 are the output of the generated scores, including various key metrics including, but not limited to, one or more of the first key metric, the second key metric, the third key metric, any additional key metrics, and the comprehensive sustainability score. For example, the metrics 822 illustrated in FIG. 8B illustrate a first key metric of the product environmental footprint, a second key metric of formulation sustainability, a third key metric of packaging sustainability, and a fourth key metric of a carbon footprint. However, these examples are presented for illustration only and should not be construed as limiting. Various examples are possible without departing from the scope of the present disclosure. In some examples, the metrics 822 are presented as text, such as a numerical score. In some examples, the metrics 822 are presented as a graph, a chart, or another visual representation of the score. In some examples, the metrics 822 are presented as a combination of text and visual representations, such as is illustrated in FIG. 8A. The product details 824 include specific aspects of the new product and their respective metrics. For example, where the new product is a formulation, as illustrated in FIG. 8A, the product details 824 include the ingredients in the formulation, the weight percent of each ingredient in the formulation, and the first key metric, the second key metric, and the third key metric for each individual ingredient in the formulation. Based on the product details 824, additional experimental assessments, such as those shown in FIG. 8A, may be performed to simulate the hypothetical change to the metrics 822 based on changing one or more ingredients in the new product.

### Example Operating Environment

FIG. 9 is a block diagram of an example computing device 900 for implementing aspects disclosed herein and is designated generally as computing device 900. Computing device 900 is an example of a suitable computing environment and is not intended to suggest any limitation as to the scope of use or functionality of the examples disclosed herein. Neither should computing device 900 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 900 includes a bus 920 that directly or indirectly couples the following devices: computer-storage memory 902, one or more processors 908, one or more presentation components 910, I/O ports 914, I/O components 916, a power supply 918, and a network component 912. While computing device 900 is depicted as a seemingly single device, multiple computing devices 900 may work together and share the depicted device resources. For example, memory 902 may be distributed across multiple devices, and processor(s) 908 may be housed with different devices.

Bus 920 represents what may be one or more busses (such as an address bus, data bus, or a combination thereof). Although the various blocks of FIG. 9 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 9 and the references herein to a “computing device.” Memory 902 may take the form of the computer-storage media references below and operatively provide storage of computer-readable instructions, data structures, program modules and other data for computing device 900. In some examples, memory 902 stores one or more of an operating system, a universal application platform, or other program modules and program data. Memory 902 is thus able to store and access data 904 and instructions 906 that are executable by processor 908 and configured to carry out the various operations disclosed herein.

In some examples, memory 902 includes computer-storage media in the form of volatile and/or nonvolatile memory, removable or non-removable memory, data disks in virtual environments, or a combination thereof. Memory 902 may include any quantity of memory associated with or accessible by computing device 900. Memory 902 may be internal to computing device 900 (as shown in FIG. 9), external to computing device 900, or both. Examples of memory 902 include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 900. Additionally, or alternatively, memory 902 may be distributed across multiple computing devices 900, for example, in a virtualized environment in which instruction processing is carried out on multiple computing devices 900. For the purposes of this disclosure, “computer storage media,” “computer-storage memory,” “memory,” and “memory devices” are synonymous terms for computer-storage memory 902, and none of these terms include carrier waves or propagating signaling.

Processor(s) 908 may include any quantity of processing units that read data from various entities, such as memory 902 or I/O components 916 and may include CPUs and/or GPUs. Specifically, processor(s) 908 are programmed to execute computer-executable instructions for implementing aspects of the disclosure. The instructions may be performed by the processor, by multiple processors within computing device 900, or by a processor external to client computing device 900. In some examples, processor(s) 908 are programmed to execute instructions such as those illustrated in the in the accompanying drawings. Moreover, in some examples, processor(s) 908 represent an implementation of analog techniques to perform the operations described herein. For example, the operations may be performed by an analog client computing device 900 and/or a digital client computing device 900. Presentation component(s) 910 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 900, across a wired connection, or in other ways. I/O ports 914 allow computing device 900 to be logically coupled to other devices including I/O components 916, some of which may be built in. Example I/O components 916 include, for example but without limitation, a microphone, joystick, game pad, satellite dish, scanner, printer, wireless device, etc.

Computing device 900 may operate in a networked environment via network component 912 using logical connections to one or more remote computers. In some examples, network component 912 includes a network interface card and/or computer-executable instructions (e.g., a driver) for operating the network interface card. Communication between computing device 900 and other devices may occur using any protocol or mechanism over any wired or wireless connection. In some examples, network component 912 is operable to communicate data over public, private, or hybrid (public and private) using a transfer protocol, between devices wirelessly using short range communication technologies (e.g., near-field communication (NFC), Bluetooths™ branded communications, or the like), or a combination thereof. Network component 912 communicates over wireless communication link 922 and/or a wired communication link 922a to a cloud resource 924 across network 926. Various different examples of communication links 922 and 922a include a wireless connection, a wired connection, and/or a dedicated link, and in some examples, at least a portion is routed through the internet.

Although described in connection with an example computing device 900, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and are non-transitory, i.e., exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

In some examples, a computer-implemented method includes designating a baseline product for a new product, the designated baseline product including at least a first baseline metric, a second baseline metric, and a third baseline metric; capturing data associated with the new product; executing a first artificial intelligence (AI) model to generate a first key metric for the new product, the first key metric associated with an environmental impact of the new product; executing a second model to generate a second key metric for the new product, the second key metric associated with a chemical analysis of the new product; executing a third model to generate a third key metric for the new product, the third key metric associated with a packaging analysis of the new product; evaluating the new product in view of the baseline product, including comparing the first baseline metric with the first key metric, the second baseline metric with the second key metric, and the third baseline metric with the third key metric; based on the evaluation, generating a recommendation for an update to the new product; and based on the generated recommendation, triggering an update to the new product.

In some examples, a system includes a memory and a processor coupled to the memory. The processor is configured to designate a baseline product for a new product, the designated baseline product including at least a first baseline metric, a second baseline metric, and a third baseline metric; capture data associated with the new product; execute a first model to generate a first key metric for the new product, the first key metric associated with an environmental impact of the new product; execute a second model to generate a second key metric for the new product, the second key metric associated with a chemical analysis of the new product; execute a third model to generate a third key metric for the new product, the third key metric associated with a packaging analysis of the new product; evaluate the new product in view of the baseline product, including comparing the first baseline metric with the first key metric, the second baseline metric with the second key metric, and the third baseline metric with the third key metric; based on the evaluation, generate a recommendation for an update to the new product; and based on the generated recommendation, trigger an update to the new product, the triggered update including an ingredient replacement in the new product.

In some examples, one or more non-transitory computer readable medium are provided. The one or more non-transitory computer readable medium stores instructions that, when executed by a processor, cause the processor to designate a baseline product for a new product, the designated baseline product including at least a first baseline metric, a second baseline metric, and a third baseline metric; capture data associated with the new product; execute a first model to generate a first key metric for the new product, the first key metric associated with an environmental impact of the new product; execute a second model to generate a second key metric for the new product, the second key metric associated with a chemical analysis of the new product; execute a third model to generate a third key metric for the new product, the third key metric associated with a packaging analysis of the new product; evaluate the new product in view of the baseline product, including comparing the first baseline metric with the first key metric, the second baseline metric with the second key metric, and the third baseline metric with the third key metric; based on the evaluation, generate a recommendation for an update to the new product; and based on the generated recommendation, trigger an update to the new product, the triggered update including an ingredient replacement in the new product.

Further examples are described herein.

Various examples further include one or more of the following:
wherein the first key metric is generated based on the first model analyzing, for the new product, raw material production, finished product manufacturing, use phase, packaging production, packaging end of life, distribution and storage, and formula end of life;
wherein the second key metric is generated based on the second model analyzing, for the new product, an environmental effect of the new product based on one or more of environmental persistence, bioaccumulation through the food chain, and direct toxicity to an aquatic organism;
wherein the third key metric is generated based on the third model analyzing, for packaging of the new product, post-consumer recycled (PCR) content of the packaging, material efficiency of the packaging, recycle readiness of the packaging, and a presence or absence of flagged materials in the packaging;
based on the generated recommendation, determining a change to at least one of a formulation of the new product or packaging of the new product that, upon implementation, is anticipated to improve one or more of the first key metric, the second key metric, or the third key metric;
wherein triggering the update to the new product includes triggering the determined change to be made to the new product;
generating a watch list score for an ingredient in the new product, the generated watch list score generated based on one or more of a plurality of factors;
wherein the plurality of factors include a likelihood of a change to the new product due to the ingredient, a timing of the change, a breadth of impact across a portfolio of products including the new product, and a technical complexity to implement the change;
based on the generated watch list score for the ingredient in the new product being greater than a threshold, generating the recommendation for the update to the new product; and
wherein the update includes replacing the ingredient in the new product with an alternative ingredient.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computer-implemented method comprising:
designating a baseline product for a new product, the designated baseline product including at least a first baseline metric, a second baseline metric, and a third baseline metric;
capturing data associated with the new product;
executing a first model to generate a first key metric for the new product, the first key metric associated with an environmental impact of the new product;
executing a second model to generate a second key metric for the new product, the second key metric associated with a chemical analysis of the new product;
executing a third model to generate a third key metric for the new product, the third key metric associated with a packaging analysis of the new product;
evaluating the new product in view of the baseline product, including comparing the first baseline metric with the first key metric, the second baseline metric with the second key metric, and the third baseline metric with the third key metric;
based on the evaluation, generating a recommendation for an update to the new product; and
based on the generated recommendation, triggering an update to the new product.

2. The computer-implemented method of claim 1, wherein the first key metric is generated based on the first model analyzing, for the new product, raw material production, finished product manufacturing, use phase, packaging production, packaging end of life, distribution and storage, and formula end of life.

3. The computer-implemented method of claim 1, wherein the second key metric is generated based on the second model analyzing, for the new product, an environmental effect of the new product based on one or more of environmental persistence, bioaccumulation through a food chain, and direct toxicity to an aquatic organism.

4. The computer-implemented method of claim 1, wherein the third key metric is generated based on the third model analyzing, for the packaging of the new product, post-consumer recycled (PCR) content of the packaging, material efficiency of the packaging, recycle readiness of the packaging, and a presence or absence of flagged materials in the packaging.

5. The computer-implemented method of claim 1, further comprising:
based on the generated recommendation, determining a change to at least one of a formulation of the new product or packaging of the new product that, upon implementation, is anticipated to improve one or more of the first key metric, the second key metric, or the third key metric,
wherein triggering the update to the new product includes triggering the determined change to be made to the new product.

6. The computer-implemented method of claim 1, further comprising:
generating a watch list score for an ingredient in the new product, the generated watch list score generated based on one or more of a plurality of factors,
wherein the plurality of factors include a likelihood of a change to the new product due to the ingredient, a timing of the change, a breadth of impact across a portfolio of products including the new product, and a technical complexity to implement the change.

7. The computer-implemented method of claim 6, further comprising:
based on the generated watch list score for the ingredient in the new product being greater than a threshold, generating the recommendation for the update to the new product,
wherein the update includes replacing the ingredient in the new product with an alternative ingredient.

8. A system comprising:
a memory; and
a processor coupled to the memory and configured to:
designate a baseline product for a new product, the designated baseline product including at least a first baseline metric, a second baseline metric, and a third baseline metric;
capture data associated with the new product;
execute a first model to generate a first key metric for the new product, the first key metric associated with an environmental impact of the new product;
execute a second model to generate a second key metric for the new product, the second key metric associated with a chemical analysis of the new product;
execute a third model to generate a third key metric for the new product, the third key metric associated with a packaging analysis of the new product;
evaluate the new product in view of the baseline product, including comparing the first baseline metric with the first key metric, the second baseline metric with the second key metric, and the third baseline metric with the third key metric;
based on the evaluation, generate a recommendation for an update to the new product; and
based on the generated recommendation, trigger an update to the new product, the triggered update including an ingredient replacement in the new product.

9. The system of claim 8, wherein, to generate the first key metric, the processor is further configured to:
control the first model to analyze, for the new product, raw material production, finished product manufacturing, use phase, packaging production, packaging end of life, distribution and storage, and formula end of life.

10. The system of claim 8, wherein, to generate the second key metric, the processor is further configured to:
control the second model to analyze, for the new product, for the new product, an environmental effect of the new product based on one or more of environmental persistence, bioaccumulation through a food chain, and direct toxicity to an aquatic organism.

11. The system of claim 8, wherein, to generate the third key metric, the processor is further configured to:
control the third model to analyze, for the packaging of the new product, post-consumer recycled (PCR) content of the packaging, material efficiency of the packaging, recycle readiness of the packaging, and a presence or absence of flagged materials in the packaging.

12. The system of claim 8, wherein:
the processor is further configured to based on the generated recommendation, determine a change to at least one of a formulation of the new product or packaging of the new product that, upon implementation, is anticipated to improve one or more of the first key metric, the second key metric, or the third key metric; and
to trigger the update to the new product, the processor is further configured to trigger the determined change to be made to the new product.

13. The system of claim 8, wherein the processor is further configured to:
generate a watch list score for an ingredient in the new product, the generated watch list score generated based on one or more of a plurality of factors,
wherein the plurality of factors include a likelihood of a change to the new product due to the ingredient, a timing of the change, a breadth of impact across a portfolio of products including the new product, and a technical complexity to implement the change.

14. The system of claim 13, wherein the processor is further configured to:
based on the generated watch list score for the ingredient in the new product being greater than a threshold, generate the recommendation for the update to the new product,
wherein the update includes replacing the ingredient in the new product with an alternative ingredient.

15. One or more non-transitory computer readable medium storing instructions that, when executed by a processor, cause the processor to:
designate a baseline product for a new product, the designated baseline product including at least a first baseline metric, a second baseline metric, and a third baseline metric;
capture data associated with the new product;
execute a first model to generate a first key metric for the new product, the first key metric associated with an environmental impact of the new product;
execute a second model to generate a second key metric for the new product, the second key metric associated with a chemical analysis of the new product;
execute a third model to generate a third key metric for the new product, the third key metric associated with a packaging analysis of the new product;
evaluate the new product in view of the baseline product, including comparing the first baseline metric with the first key metric, the second baseline metric with the second key metric, and the third baseline metric with the third key metric;
based on the evaluation, generate a recommendation for an update to the new product; and
based on the generated recommendation, trigger an update to the new product, the triggered update including an ingredient replacement in the new product.

16. The one or more non-transitory computer readable medium of claim 15, further storing instructions to generate the first key metric that, when executed by the processor, cause the processor to:
control the first model to analyze, for the new product, raw material production, finished product manufacturing, use phase, packaging production, packaging end of life, distribution and storage, and formula end of life.

17. The one or more non-transitory computer readable medium of claim 15, further storing instructions to generate the second key metric that, when executed by the processor, cause the processor to:
control the second model to analyze, for the new product, for the new product, an environmental effect of the new product based on one or more of environmental persistence, bioaccumulation through a food chain, and direct toxicity to an aquatic organism.

18. The one or more non-transitory computer readable medium of claim 15, further storing instructions to generate the third key metric that, when executed by the processor, cause the processor to:
control the third model to analyze, for the packaging of the new product, post-consumer recycled (PCR) content of the packaging, material efficiency of the packaging, recycle readiness of the packaging, and a presence or absence of flagged materials in the packaging.

19. The one or more non-transitory computer readable medium of claim 15, further storing instructions that, when executed by the processor, cause the processor to:
based on the generated recommendation, determine a change to at least one of a formulation of the new product or packaging of the new product that, upon implementation, is anticipated to improve one or more of the first key metric, the second key metric, or the third key metric; and
to trigger the update to the new product, trigger the determined change to be made to the new product.

20. The one or more non-transitory computer readable medium of claim 15, further storing instructions that, when executed by the processor, cause the processor to:
generate a watch list score for an ingredient in the new product, the generated watch list score generated based on one or more of a plurality of factors, wherein the plurality of factors include a likelihood of a change to the new product due to the ingredient, a timing of the change, a breadth of impact across a portfolio of products including the new product, and a technical complexity to implement the change; and
based on the generated watch list score for the ingredient in the new product being greater than a threshold, generate the recommendation for the update to the new product,
wherein the update includes replacing the ingredient in the new product with an alternative ingredient.
